(19) United States
(12) Patent Application Publication
(10) Pub. No.: US 2022/0097069 A1
(43) Pub. Date: Mar. 31, 2022

(54) STORAGE DEVICE

(71) Applicant: DNAE DIAGNOSTICS LIMITED, London (GB)

(72) Inventors: Matthew SPRINGER, London (GB); John Luis TASSONE, London (GB); Simeon Dominic CASTLE, London (GB); Lee PEARSON, South Bucks (GB)

(73) Assignee: DNAE DIAGNOSTICS LIMITED, London (GB)

(21) Appl. No.: 17/426,797

(22) PCT Filed: Jan. 31, 2020
(86) PCT No.: PCT/GB2020/050232

§ 371 Date: Jul. 29, 2021

(30) Foreign Application Priority Data
Feb. 1, 2019 (GB) 1901428.1

(51) Int. Cl. B01L 3/00

(52) U.S. Cl. CPC B01L 3/523; B01L 2200/16; B01L 2300/042; B01L 2300/0672; B01L 2300/0832; B01L 2300/044

(57) ABSTRACT

A device is provided for preserving the integrity of one or more reagents on a substantially planar cartridge. The device includes a chimney extending substantially perpendicular to the plane of the cartridge, a bead holder encapsulated within the chimney; and a piercing mechanism located within the chimney and configured to enable a bead to access the bead holder, in use.

### TECHNICAL FIELD

The present disclosure relates to a storage device. Aspects of the invention relate to a device for preserving the integrity of one or more reagents; and to a cartridge comprising a device for preserving the integrity of one or more reagents.

### BACKGROUND

It is known to store a dry reagent and a wet reagent on a diagnostic cartridge. The dry reagent may, for example, comprise a lyophilised bead. The dry reagent may be exposed to moisture in the form of a vapour from the wet reagent, for example. The integrity of reagents may be adversely affected by moisture ingress, especially during storage over a prolonged period of time. It has been recognised that it would be desirable to reduce the moisture vapour transfer rate from the wet reagent to the dry reagent. Furthermore, if there is not efficient sealing between parts, amplicons can move between different regions of the cartridge resulting in contamination.

It is an aim of the present invention to address one or more of the disadvantages associated with the prior art.

### SUMMARY OF THE INVENTION

Aspects and embodiments of the invention provide a device for preserving the integrity of one or more reagents; and to a cartridge comprising a device for preserving the integrity of one or more reagents as claimed in the appended claims

According to an aspect of the present invention there is provided a device for preserving the integrity of one or more reagents on a substantially planar cartridge, the device comprising: a chimney extending substantially perpendicular to the plane of the cartridge, a bead holder encapsulated within the chimney; and a piercing mechanism located within the chimney and configured to enable a bead to access the bead holder, in use.

The integrity of reagents on a cartridge may be challenged by moisture ingress especially when it is stored for a protracted period of time. Furthermore, if there is not efficient sealing between parts, amplicons can move between the parts and contaminate parts of the cartridge where they are not intended to be.

The chimney may provide an upstanding physical barrier to fluid or moisture movement. It may be shaped and sized in order to accommodate the bead holder.

The piercing mechanism may be configured to pierce and remove a covering, typically a foil closure, thus enabling access to the reagents contained within the enclosure. These reagents will then move into the device and the bead or beads will be accommodated by the bead holder.

The chimney may be formed as a separate component which may be mounted to or fastened to the cartridge. Alternatively, the chimney may be integrally formed with the cartridge. Providing an integral chimney may be advantageous in that manufacture cost may be contained. By forming the chimney integral with the cartridge there is no risk of misalignment during manufacture and, furthermore, the chimney will be formed from the same material as the cartridge ensuring that no issues arise from different thermal properties of different materials.

The chimney may have a transverse cross-section which is polygonal, for example in the form of a square or a rectangle. Alternatively, the chimney may have a transverse cross-section which is elliptical or oval in shape. Alternatively, the chimney may have a transverse cross-section which is substantially circular.

The chimney may be cylindrical. The cylindrical chimney may have a circular cross section or the cross section may be oval as dictated by the packaging requirements of the cartridge. The key aspect of the cylindrical chimney is that it lacks corners. Corners raise stress and can be challenging in both manufacture and use. Therefore the provision of a cylindrical chimney obviates the need for corners, thereby reducing the manufacturing constraints.

The bead holder may be cylindrical. The bead holder may be concentric with the chimney. This configuration provides rotational symmetry to distribute forces equally around the device.

The bead holder may be provided with a retainer to secure the bead holder to the chimney.

An O-ring may be provided to secure the bead holder to the chimney. The O-ring may be retained in a retainer which is formed as an annular indentation running around the outer face of the bead holder. This embodiment may be alignment free and may be more tolerant of manufacturing variability. Furthermore, the chimney in this embodiment may be provided with an annular taper on the upper edge in order to aid assembly.

The chimney may be provided with a retainer to secure the bead holder to the chimney. The retainer may be provided in the form of a plurality of indentations and/or protrusions. These may be provided rotationally symmetrically around the device. There may be two, three, four or more retainers provided around the circumference of the device. The indentations may be provided on the chimney with corresponding protrusions on the bead holder. Alternatively, or additionally, the chimney may be provided with protrusions and the bead holder with indentations. The clip may extend perpendicular to the plane of the cartridge and comprise a tapered portion which, being formed of thinner material than the surrounding parts, will deform more easily. The tapered portion may lead to a bulbous head with a flat face which may be configured to interface with a corresponding face on the corresponding part of the retainer.

The indentations may extend right through the chimney and/or bead holder in some parts to provide cut away portions.

The bead holder may comprise a baffle. The baffle may be concentrically positioned outside of the bead holding portion and the desiccant holder of the bead holder. This may be particularly important in those embodiments in which there are cut away portions in the chimney to facilitate the attachment of the bead holder to the chimney.

The bead holder may comprise a desiccant holder. The desiccant holder may be a cup shaped section of the bead holder that may be integrally formed therewith. The desiccant holder may comprise desiccant. The desiccant may be powdered, granulated or provided in the form of beads or other similar shapes. The device as a whole may be designed and configured to prevent the ingress of moisture. However, there may be a requirement to deal with moisture that does move into the device.

The desiccant holder may include a lid. This prevents the desiccant moving from its intended location within the desiccant holder. This may be especially important if the desiccant is powdered.

The chimney may further comprise an alignment feature. The alignment feature may be provided on the upper surface of the chimney. It may be advantageous deployed in any embodiments that have a non-annular retainer. In these embodiments the indentations and protrusions must align in order to effect a successful connection between the bead holder and then chimney. The alignment feature may identify the orientation of the bead holder that is required to create this alignment. A corresponding alignment feature may be provided on the bead holder to provide positive confirmation that the chimney and bead holder have been correctly aligned.

The device may be positioned above a well on the cartridge. The well may be the chamber in which the reactions take place on the cartridge.

The bead holder may be arcuate. The bead holding surface of the bead holder may be arcuate in order to accommodate a range of bead sizes. The lower extremity of the domed bead holder may be formed into a tapered seal in order to provide a seal enclosing the bead holder and the well below and separating this volume from the rest of the cartridge.

The chimney may comprise at least one vent. The chimney may comprise a plurality of vents. The vents preferably extend perpendicular to the plane of the cartridge. A plurality of vents may be provided, equally spaced, around the inner circumference of the chimney. There may be two separate sets of vents. A first set of vents extend from the top of the chimney down to a mid-point. These vents may be utilised during the manufacture of the cartridge as the bead holder is brought into position within the chimney. A second set of vents may also be provided below the first set of vents. These vents are utilised during use of the cartridge as the bead holder moves relative to the chimney in order to pierce the reagent holder and commence operation of the cartridge. Both sets of vents are provided to avoid pressurisation of the interior of the device either during manufacture or during use. The first and second sets of vents may be aligned. This configuration may provide ease of manufacture. However, it may be not be necessary for the operation of the device.

The device may comprise sealing means for sealing the bead within the bead holder. The sealing means may comprise cooperating first and second surfaces. The first and second surfaces may be arranged to cooperate with each other to form a seal. The seal may be at least substantially fluid-tight. The sealing means may comprise a taper seal. The first and second cooperating surfaces may be conical. The first and second surfaces may have complementary taper angles.

According to a further aspect of the present invention there is provided a device for storing one or more reagents, the device comprising: a housing; and a body comprising a compartment for storing the reagent, the compartment being sealed by a frangible member; and a piercing member disposed within the housing; wherein, in use, the body is movable relative to the housing to cause the piercing member to pierce the frangible member to open the compartment.

The compartment may be sealed by the frangible member. The frangible member may comprise a membrane. The membrane may, for example, comprise a cover or a cap. The membrane may be formed from a plastics material, a foil or other material.

The body may comprise a reagent holding member. The reagent holding member may be elongated, for example in the form of a cylindrical member extending along a longitudinal axis. A recess may be provided for receiving the reagent. The recess may, for example, be in the form of a cup. The recess may be formed at a distal end of the reagent holding member.

The housing may comprise a well or an aperture for receiving the reagent after the device is actuated and the frangible member pierced. The well or the aperture may be formed at least partially by a wall member. The piercing member may be disposed on the wall member. The piercing member may be formed integrally with the wall member. The wall member may be in the form of a cylindrical wall. The reagent holding member and the cylindrical wall may be substantially concentric. The distal end of the reagent holding member may be configured to locate within the cylindrical wall when the body is displaced relative to the housing.

The housing may comprise a chimney, for example in the form of an outer wall. An annular chamber may be formed between the chimney and the cylindrical wall formed in the housing. The body may comprise an intermediate wall arranged to locate in the annular chamber when the device is actuated. The frangible member may be fastened to the intermediate wall to seal the compartment in which the reagent is stored. In use, the intermediate wall may travel past the cylindrical wall formed around the wall. The movement of the intermediate wall past the cylindrical wall may help to displace the frangible member clear of the well.

The device may comprise sealing means for sealing the well. The sealing means may, for example, comprise a consumable membrane or the like. The seal formed by the sealing means may be at least substantially fluid-tight. The sealing means may be formed by cooperating first and second surfaces formed on the body and the housing respectively. The second surface may, for example, be an inner surface of the cylindrical wall extending around the well. The sealing means may comprise a taper seal. The first and second surfaces may be conical. The first and second surfaces may have complementary taper angles.

According to a further aspect of the present invention there is provided a device for storing one or more reagents, the device comprising: a body comprising a compartment for storing the reagent; a well for receiving the reagent; and sealing means for sealing the well.

The compartment may be sealed, for example by a frangible member. The frangible member may comprise a membrane, such as a cover. A piercing member may be provided for piercing the frangible member. The body may be movable to cause the piercing member to pierce the frangible member such that the compartment is opened. The sealing means may be configured to form a seal when the body is displaced to cause the piercing member to pierce the frangible member. The seal may be at least substantially fluid-tight.

The sealing means may comprise cooperating first and second surfaces formed on the body and the well respectively. The first and second surfaces may be arranged to cooperate with each other to form a seal. The sealing means may comprise or consist of a taper seal. The first and second surfaces may be conical. The first and second surfaces may have complementary taper angles.

According to a further aspect of the present invention there is provided a cartridge comprising a device as described herein. The cartridge may be a diagnostic cartridge which may be configured for use independently or within a diagnostic apparatus.

### BRIEF DESCRIPTION OF THE DRAWINGS

One or more embodiments of the invention will now be described, by way of example only, with reference to the accompanying drawings, in which:

FIG. 1 shows a cartridge comprising a storage device for storing a reagent in accordance with an embodiment of the present invention;

FIG. 2 shows a first sectional view of the storage device shown in FIG. 1 in a storage configuration for storing the reagent;

FIG. 3 shows a perspective view of a chimney of the storage device shown in FIG. 2;

FIG. 4 shows a perspective view of a bead holder of the storage device shown in FIG. 2;

FIG. 5 shows a sectional view of the storage device in a first partially actuated configuration;

FIG. 6 shows a sectional view of the storage device in a second partially actuated configuration;

FIG. 7 shows a sectional view of the storage device in an actuated configuration;

FIG. 8 shows a sectional view of the storage device during a process following actuation;

FIG. 9 shows a sectioned perspective view of a storage device according to a second embodiment of the present invention;

FIG. 10 shows a sectioned perspective view of a variant of the storage device shown in FIG. 9; and

FIG. 11 shows a sectioned perspective view of a storage device according to a third embodiment of the present invention.

### DETAILED DESCRIPTION

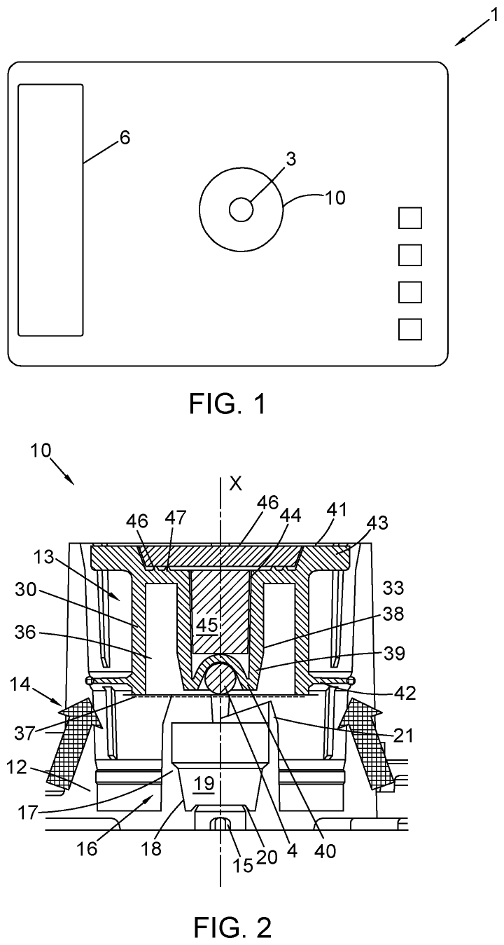

A cartridge 1 for performing a diagnostic test is shown in FIG. 1. The cartridge 1 is configured to be inserted into a diagnostic apparatus, for example to perform analysis of a blood sample. The cartridge 1 in the present embodiment is generally planar and comprises a well 3. In use, a reagent 4 is dissolved in a liquid 5 in the well 3. The liquid 5 may, for example, comprise a wet reagent stored in a reservoir (not shown) provided on the cartridge 1. A disposable container 6 may be mounted to the cartridge 1, for example to deliver a test sample.

The cartridge 1 comprises a storage device 10 in accordance with an embodiment of the present invention. The reagent 4 for use in the diagnostic test is stored in the storage device 10. As described herein, the storage device 10 can be selectively actuated to release the reagent 4. The reagent 4 in the present embodiment is a dry reagent and is formed as a bead, such as a lyophilised bead. It will be understood that other types and forms of reagent 4 may be stored in the storage device 10.

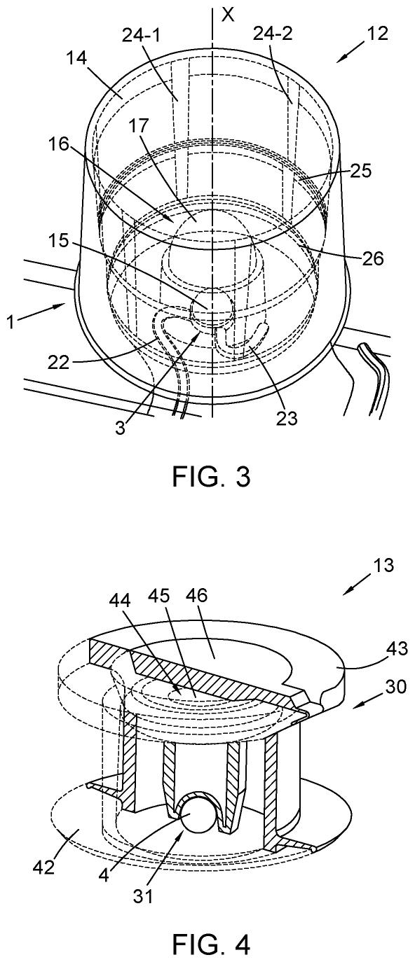

A sectional view of the storage device 10 is shown in FIG. 2. The storage device 10 comprises a base unit 12 and a bead holder 13. A sectional view of the base unit 12 is shown in FIG. 2; and a perspective view of the bead holder 13 is shown in FIG. 3. The base unit 12 comprises a chimney 14 in the form of a cylindrical wall. The chimney 14 has a central longitudinal axis X which extends substantially perpendicular to the plane of the cartridge 1. As described herein, the bead holder 13 is movable along the longitudinal axis X to actuate the storage device 10. The chimney 14 is configured to control movement of the bead holder 13 in order to limit or prevent non-axial movement. A central aperture 15 is formed in the base unit 12 for alignment with the well 3 formed on the cartridge 1. In a variant, the well 3 may be formed in the base unit 12 of the storage device 10. The base unit 12 and the bead holder 13 are moulded from a plastics material, such as polypropylene. The base unit 12 may be formed integrally with the cartridge 1 or may be formed as a separate component which is fastened to the cartridge 1.

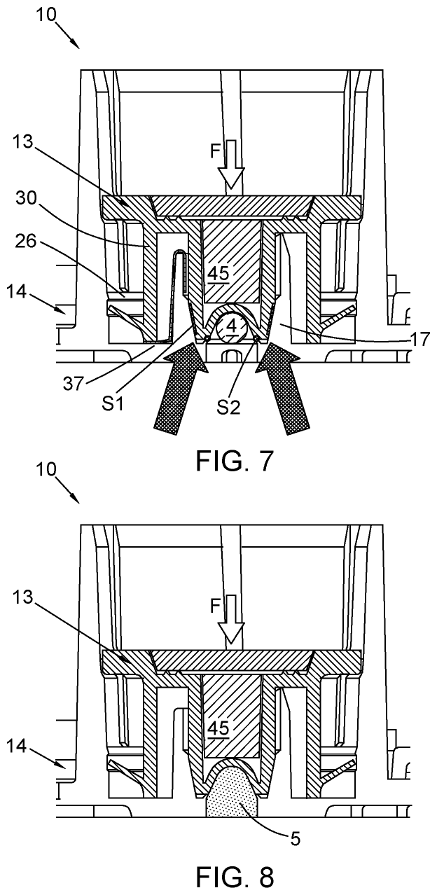

The base unit 12 comprises engagement means 16 for engaging the bead holder 13 when the storage device 10 is actuated. The engagement means 16 comprises an inner cylindrical wall 17 which forms a seat for receiving the bead holder 13. The inner cylindrical wall 17 has an inner surface 18 comprising a first sealing surface 19. The first sealing surface 19 has a frusto-conical profile and is tapered towards the central aperture 15. An annular lip 20 is formed on the base unit 12 around the central aperture 15. The first sealing surface 19 and the annular lip 20 are configured to form respective first and second seals S1, S2 (shown in FIG. 7) for sealing the well 3. It will be understood that the annular lip 20 may be omitted in certain embodiments. The base unit 12 comprises piercing means for piercing the bead holder 13. In the present embodiment, the piercing means is formed integrally with the inner cylindrical wall. In particular, a distal end of the inner cylindrical wall 17 is profiled to form a piercing member 21. The piercing member 21 in the present embodiment is formed on one side of the inner cylindrical wall 17 and comprises a reduced thickness and is tapered to a point.

An inlet channel 22 and an outlet channel 23 are formed in the base unit 12. The inlet channel 22 and the outlet channel 23 are in fluid communication with the central aperture 15. In use, a liquid is controllably supplied to the well 3 through the inlet channel 22 to mix with the reagent 4 in the well 3. The solution may be transported from the well 3 through the outlet channel 23.

A plurality of vents 24-n (where n is an integer) are formed on an inner surface of the chimney 14. Each vent 24-n comprises a channel or groove formed on the inner surface of the chimney 14 extending substantially parallel to the longitudinal axis X. The vents 24-n are provided to allow air to escape past the bead holder 13 during assembly and/or when the bead holder 13 is actuated. First and second circumferential grooves 25, 26 are formed in the inner surface of the chimney 14. The first and second circumferential grooves 25, 26 are spaced apart from each other along the longitudinal axis X.

The bead holder 13 comprises a body 30 forming a first storage chamber 31, a body wall 32 and a reagent holder 33. The reagent holder 33 is generally cylindrical in shape and is elongated along the longitudinal axis X. A recess 35 in the form of a cup is formed at a distal end of the reagent holder 33 for receiving the reagent 4.

The body wall 32 comprises a cylindrical wall disposed radially outwardly of the reagent holder 28. The body wall 32 and the reagent holder 33 are concentric about the longitudinal axis X. A first annular chamber 36 is formed between the body wall 32 and the reagent holder 33 to receive at least a portion of the inner cylindrical wall 17 of the base unit 12. The bead holder 13 comprises a membrane 37 for sealing the first storage chamber 31 to preserve the reagent 4. The membrane 37 is operative to prevent the ingress of moisture and/or contaminants to the first storage chamber 31. The membrane 37 is adhesively fastened to the body wall 32 and seals the first storage chamber 31. The membrane 37 in the present embodiment comprises a foil cap, for example a heat-sealed foil. Other types of consumable contamination seal are also contemplated. The membrane 37 may also help to retain the reagent 4 in the recess 35. The membrane 37 is frangible to enable the reagent 4 to be released from the recess 35. In particular, the membrane 37 is configured to be pierced by the piercing member 21 when the storage device 10 is actuated. To facilitate release of the reagent 4, the membrane 37 is not fastened to the reagent holder 33 such that it may more readily be displaced clear of the reagent holder 28.

The distal end of the reagent holder 33 has an outer surface 38 which is profiled to form a second sealing surface 39. The second sealing surface 39 is configured to cooperate with the first sealing surface 19 to form the first seal S1 when the storage device 10 is actuated. The second sealing surface 39 in the present embodiment has a frusto-conical profile. The reagent holder 33 has an end face 40 arranged to engage the annular lip 20 to form the second seal 21 when the storage device 10 is actuated.

The bead holder 13 is movably mounted in the chimney 14. An upper surface 41 of the body 30 forms an actuating surface for actuating the storage device 10. The body 30 comprises an annular member 42 for cooperating with an interior of the chimney 14. The annular member 42 extends radially outwardly and is deformable to accommodate changes in the diameter of the inner surface of the chimney 14. The annular member 42 forms a baffle configured to engage the inner surface of the chimney 14. As outlined above, the chimney 14 comprises first and second circumferential grooves 25, 26. The annular member 42 is configured selectively to locate in the first and second circumferential grooves 25, 26 to form a lip seal with the chimney 14. The first and second circumferential grooves 25, 26 are separated along the longitudinal axis X and define first and second axial positions for the bead holder 13. An annular flange 43 is formed at an upper end of the body 30. The annular flange 43 locates within the chimney 14 and may help to maintain alignment of the body 13 relative to the chimney 40.

In the present embodiment, the body 30 comprises a second storage chamber 44 for storing a desiccant 45. The second storage chamber 44 is separate from the first storage chamber 31. A lid 46 is provided in the upper surface 41 of the body 30 to close the second storage chamber 44. The lid 46 is hingedly connected to the body 30, for example by a live hinge (not shown) moulded integrally with the body 30. The desiccant 45 is a powdered desiccant in the present embodiment. A seal may be provided on the body 30 to seal the second storage chamber 44. In the present embodiment, first and second annular seals 46, 47 are provided around the second storage chamber 44 to engage an underside of the lid 46 to form a seal. A retaining means (not shown), such as a clasp, is provided for securing the lid 46 in a closed position.

The fabrication and assembly of the storage device 10 will now be described. The base unit 12 and the bead holder 13 are moulded from a plastics material, such as polypropylene, as separate components. The base unit 12 and the bead holder 13 may be moulded from the same material or different materials. The reagent 4 is located in the recess 35 and the membrane 37 applied. As outlined above, the membrane 37 is adhered to the body wall 32, thereby sealing the first storage chamber 31. The desiccant 45 is introduced into the second storage chamber 44 and the lid 46 closed. The bead holder 13 is introduced into the chimney 14. The vents 24-n formed in the inner surface of the chimney 14 allow air to vent past the annular member 42 when the body 30 is inserted. The body 30 is displaced along the longitudinal axis X until the annular member 42 locates in the first circumferential groove 25 formed in the inner surface of the chimney 14. The storage device 10 is in a storage configuration with the bead holder 13 in this first axial position. As shown in FIG. 2, the chimney 14 extends around the body 30 and forms a protective element. The possibility of the storage device 10 being actuated inadvertently is reduced since the body 30 does not extend above the height of the chimney 14 when in the storage configuration.

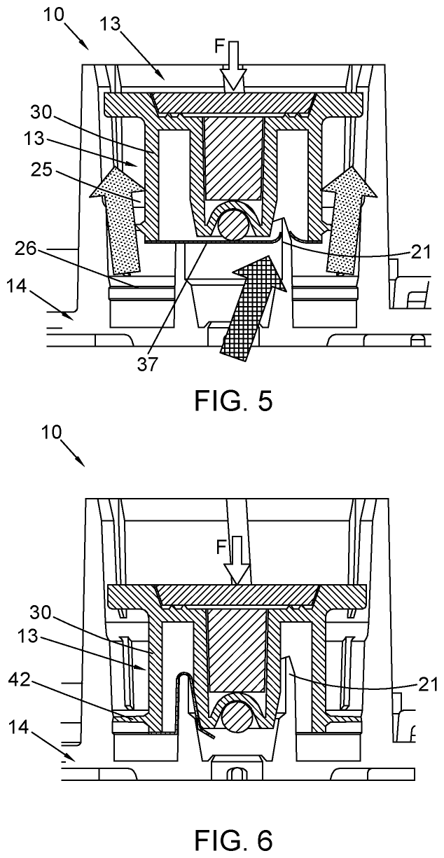

The storage device 10 is actuated by displacing the body 30 along the longitudinal axis X of the chimney 14. The operation of the storage device 10 will now be described in more detail. The body 30 is initially in the first axial position with the annular member 42 disposed in the first circumferential groove 25, as shown in FIG. 2. The membrane 37 is intact and the first storage chamber 31 is sealed. An actuating force F is applied to the upper surface 41 of the body 30, as illustrated by arrow 50. The actuating force F causes the bead holder 13 to be displaced along the longitudinal axis X. The actuating force F may be applied by an actuator, such as a piston (not shown). The annular member 42 is displaced out of the first circumferential groove 25 and air vents past the body 30 through the vents 24-n. As shown in FIG. 5, the displacement of the body 30 causes the piercing member 21 to pierce the membrane 37. The continued displacement of the body 30 (in dependence on the application of the actuating force F) severs the membrane 37. As shown in FIG. 6, the membrane 37 is engaged by a section of the inner cylindrical wall 17 diametrically opposed from the piercing member 21. The inner cylindrical wall 17 travels alongside the reagent holder 33 causing the membrane 37 to be displaced away from the bead holder 13. The body 30 is displaced to the second axial position such that the annular member 42 locates in the second circumferential groove 26. The actuator force F displaces the body 30 to a fully actuated position in which the first and second sealing surfaces 19, 39 engage each other to form the first seal S1, as shown in FIG. 7. The end face 40 of the reagent holder 33 also engages the annular lip 20 to form the second seal S2, as shown in FIG. 7. In this position, the bead holder 13 is seated within the inner cylindrical wall 17 to form the first and second seals S1, S2 around the central aperture 15. A liquid 5 is introduced into the central aperture 15 to remove and mix the reagent 4, as illustrated in FIG. 8. The diagnostic test(s) are performed using appropriate techniques.

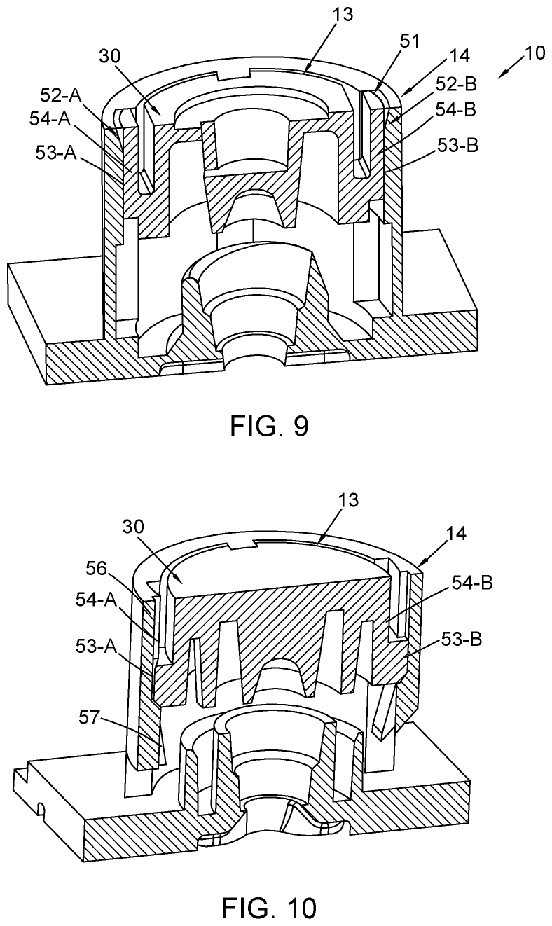

It will be understood that various changes and modifications may be made to storage device 10. A storage device 10 in accordance with a second embodiment of the present invention is shown in FIG. 9. Like reference are used for like components.

The storage device 10 according to the second embodiment comprises alignment means 51 for aligning the bead holder 13 with the chimney 14. In particular, the alignment means 51 is operative to inhibit or limit rotation of the bead holder 13 relative to the chimney 14. The alignment means 51 comprises cooperating male and female features. In the present embodiment, the alignment means 51 comprises opposing first and second guide members 52A, 52B provided on the body 30. The first and second guide members 52A, 52B are arranged to travel in respective first and second channels 53A, 53B formed in the inner surface of the chimney 14. The first and second guide members 52A, 52B comprise respective first and second resilient arms 54A, 54B which are displaced inwardly when the body 30 is displaced into the chimney 14 (by the actuating force F). The first and second guide members 52A, 52B may optionally configured to cooperate with respective first and second stops 55A, 55B to inhibit withdrawal of the body 30. When the storage device 10 is fully actuated, the first and second resilient arms 54A, 54B are biased outwardly and engage the first and second stops 55A, 55B. The body 30 is thereby locked in the fully actuated configuration. This non-return function may be implemented with or without the alignment means 51. For example, one or more locking member may be provided to engage an annular or part-annular recess to retain the body 30 in the actuated configuration.

A variant of the storage device 10 according to the second embodiment of the present invention is shown in FIG. 10. In this variant, the storage device 10 comprises retaining means for retaining the body 30 in the chimney 14. In particular, the first and second channels 53A, 53B are configured to cooperate with the first and second guide members 52A, 52B to retain the body 30 in the chimney 14. The first and second channels 53A, 53B each comprise a radial step for cooperating with the first and second guide members 52A, 52B to retain the body 30 in a first axial position for storage. The first and second channels 53A, 53B each comprise a first inclined surface (ramp) 56 for guiding the first and second resilient arms 54A, 54B into the radial step; and a second inclined surface (ramp) 57 for guiding the first and second resilient arms 54A, 54B from the radial step to a second axial position.

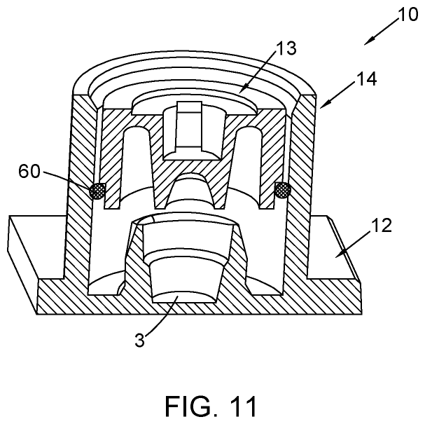

A seal may be established between the bead holder 13 and the chimney 14. A storage device 10 in accordance with a further embodiment of the present invention is shown in FIG. 11. Like reference numerals are used for like components.

The storage device 10 according to the third embodiment comprises an annular seal 60 between the bead holder 13 and the chimney 14. In the illustrated arrangement, the annular seal 60 comprises an O-ring, for example formed from an elastomeric material. One or both of the bead holder 13 and the chimney 14 may comprise an annular indentation 61, 62 for locating the O-ring. The annular indentation(s) 61 may be formed around the outer face of the bead holder 13. At least in certain embodiments, this arrangement may be alignment free and may be more tolerant of manufacturing variability. The chimney 14 in this embodiment may comprise an annular taper on the upper edge in order to facilitate assembly of the storage device 10. As shown in FIG. 11, the well 3 may optionally be formed in the base unit 12.

It will be appreciated that various changes and modifications can be made to the present invention without departing from the scope of the present application. For example, in a modified arrangement, the bead holder 13 and the chimney 14 may have cooperating threads to enable relative linear displacement when the bead holder 13 is rotated relative to the chimney 14. The application of a torque to the bead holder 13 would rotate the bead holder 13 causing it to be displaced in an axial direction and the membrane to be pierced.

1-15. (canceled)

16. A device for storing one or more reagents, the device comprising:
a housing comprising a piercing member disposed therein; and
a body comprising a compartment for storing the reagent, the compartment sealed by a frangible member,
wherein, in use, the body is movable relative to the housing to cause the piercing member to pierce the frangible member to open the compartment.

17. The device according to claim 16, wherein the body is a reagent holding member.

18. The device according to claim 17, wherein the reagent holding member is elongate and/or wherein the reagent holding member is in the form of a cylindrical member extending along a longitudinal axis.

19. The device according to claim 17, wherein the housing comprises a well or an aperture for receiving the reagent after the device is actuated and the frangible member pierced.

20. The device according to claim 19, wherein the well or the aperture is formed, at least partially, by a wall member.

21. The device according to claim 20, wherein the piercing member is disposed on the wall member.

22. The device according to claim 20, wherein the piercing member is formed integrally with the wall member.

23. The device according to claim 20, wherein the wall member is in the form of a cylindrical wall.

24. The device according to claim 23, wherein the reagent holding member and the cylindrical wall are substantially concentric.

25. The device according to claim 16, wherein the housing comprises a chimney in the form of an outer wall.

26. The device according to claim 16, wherein an annular chamber is formed between the chimney and the cylindrical wall formed in the housing.

27. The device according to claim 16, wherein the body comprises an intermediate wall arranged to locate in the annular chamber when the device is actuated and wherein the frangible member is fastened to the intermediate wall to seal the compartment in which the reagent is stored.

28. The device according to claim 16, further comprising sealing means for sealing the well.

29. The device according to claim 28, wherein the sealing means comprises a consumable membrane or the like and/or the seal formed by the sealing means is at least substantially fluid-tight.

30. The device according to claim 28, wherein the sealing means is formed by cooperating first and second surfaces formed on the body and the housing respectively.
